(19) United States
(12) Patent Application Publication
(10) Pub. No.: US 2010/0224674 A1
(43) Pub. Date: Sep. 9, 2010

(54) FIXTURE APPARATUS FOR LOW-TEMPERATURE AND LOW-PRESSURE SINTERING

(75) Inventors: Chunlei LIU, Zurich (CH); Samuel Hartmann, Wohlenschwil (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 12/716,412

(22) Filed: Mar. 3, 2010

(30) Foreign Application Priority Data
Mar. 4, 2009 (EP) 09154319.9

(51) Int. Cl. B23K 31/02; B23K 37/04

(52) U.S. Cl. 228/212; 228/44.3

(57) ABSTRACT

The disclosure relates to bonding plural elements by sintering a bonding layer sandwiched between the elements. An exemplary embodiment includes a support frame; a clamping device; a reception region for receiving a stack including the plural elements, in-between which the bonding layer is arranged, wherein the stack is clamped when loaded into the reception region to permanently apply a sintering pressure. An exemplary method is also disclosed for bonding plural of elements using a sintering process. The method includes clamping the stack into a reception region of a fixture device, and applying heat to the stack and the bonding layer to perform a sintering process of the bonding layer.

### RELATED APPLICATIONS

This application claims priority under 35 U.S.C. §119 to European Patent Application No. 09154319.9 filed in Europe on Mar. 4, 2009, the entire content of which is hereby incorporated by reference in its entirety.

### FIELD

The present disclosure relates to bonding of elements, such as electronic devices, silicon dies, metal plates, diverse metal an protection layers and the like (e.g., for bonding a chip onto a substrate).

### BACKGROUND INFORMATION

Silver sintering is a known method for low-temperature bonding (e.g., for bonding an element such as an electronic device, a silicon die or the like, onto another element, such as a silicon die, a substrate or another electronic device). The process of silver sintering allows electrical and mechanical interconnecting of elements (e.g. a die and a substrate) at a low temperature and low pressure such that the resulting interconnection provides a sufficient electrical conductivity and a low heat resistivity. In comparison to soldered die bonds, the sintered joints show a higher reliability and a higher operating temperature capability. For instance, it has been shown that power modules with sintered chip-attachment have a three times better performance, a five times better reliability, and a higher chip junction temperature up to 175° C.

In the bonding process, a layer of a paste including nanoscale or microscale silver powder may be applied between the elements to be bonded. Thereafter, pressure and heat can be supplied simultaneously for a duration of several minutes. The bonding process can be performed using a press that has a heating integrated in its press stamp to simultaneously apply a pressure (e.g., about 8 MPa) and heat (e.g., about 300° C.). Since the conditions are maintained for several minutes, the throughput of a bonding apparatus having such a press is limited.

### SUMMARY

A fixture apparatus is disclosed for bonding plural elements by sintering a bonding layer between the elements, the apparatus comprising: a support frame; a clamping means; and a reception region for receiving a stack having plural elements, in-between which a bonding layer is arranged, the clamping means clamping a stack when loaded into the reception region for permanently applying a sintering pressure.

A method is disclosed for bonding plural elements by a sintering process to produce a stack of elements, comprising: clamping the stack into a reception region of a fixture apparatus which includes a support frame, a clamping means, and the reception region for receiving a stack having plural elements, in-between which a bonding layer is arranged, the clamping means clamping the stack when loaded into the reception region for permanently applying a sintering pressure; and applying heat to the elements and the bonding layer to perform a sintering process of the bonding layer after the stack has been clamped to the reception region.

### BRIEF DESCRIPTION OF THE DRAWINGS

In the following description, exemplary embodiments are described in detail in conjunction with the accompanying drawings, in which:

FIG. 1 shows a cross-sectional view of an exemplary fixture apparatus loaded with a die stacked on a substrate;

FIGS. 2a and 2b show a cross-sectional view of an exemplary fixture apparatus loaded with three stacks of elements in an unassembled and assembled state;

FIGS. 3a and 3b show a cross-sectional view of an exemplary fixture apparatus loaded with three stacks of elements in an unassembled and assembled state;

FIG. 4 shows a cross-sectional view of an exemplary fixture apparatus for bonding a plurality of dies on a substrate simultaneously;

FIG. 5 shows a cross-sectional view of an exemplary fixture apparatus for bonding a plurality of dies on a substrate simultaneously.

### DETAILED DESCRIPTION

An apparatus and a method are disclosed for a bonding process using sintering to, for example, increase efficiency and overall throughput for bonding a plurality of elements in a production line.

According to a first exemplary aspect, a fixture apparatus for bonding a plurality of elements by sintering a bonding layer sandwiched between the elements is provided. An exemplary fixture apparatus can include a support frame, a clamping means, and a reception region for receiving a stack including a plurality of elements in-between which the bonding layer is arranged. The clamping means can be adapted to clamp the stack when loaded into the reception region and to permanently apply a sintering pressure.

In an exemplary embodiment disclosed herein, a process of applying pressure can be separated from the process of applying heat. This can be performed by means of the above fixture apparatus, which allows permanent application of the sintering pressure onto elements to be bonded during the sintering process without the need of an appropriate press. Thus, the fixture apparatus loaded with the elements allows the sintering pressure to be maintained while the stack including the elements and the bonding layer loaded into the fixture apparatus are exposed to heat in order to perform the sintering process. The bonding layer can be a metal paste, such as silver paste with micro or nano silver particles, which can also include silver compounds.

The fixture apparatus may be constructed to permanently apply pressure on the plurality of elements (e.g., a plurality of stacked dies or a die on a substrate) by means of a force-applying element. The fixture apparatus loaded with the one or more stacked elements can then be exposed to heat such that the sintering process is performed.

Known art press units apply heat and pressure simultaneously on stacked elements and maintain pressure for a significant period of time as already mentioned. In contrast thereto, the fixture apparatus loaded with the stack including the devices and/or substrates can enable bonding to be performed by maintaining the sintering pressure while the sintering temperature is applied separately.

Furthermore, the clamping means may be adapted to receive the stack biased with the sintering pressure and to clamp the stack while maintaining the sintering pressure. For example, the sintering pressure may be in the range from 1 to 20 MPa. In an exemplary embodiment ,the clamping means may include a spring.

In alternative embodiments, the support frame may have a support portion and a pressure maintaining portion wherein the sintering pressure is applied on the stack received in a reception region by assembling the support portion, and the pressure maintaining portion thereby biasing a force-applying element of the clamping means to provide the sintering pressure. For example, the support portion and the pressure maintaining portion can be fastened to each other by means of one or more screws, or by means of a fastening bolt or other suitable fastener.

Moreover, the clamping means may, for example, have a stamp which includes a material having a thermal expansion coefficient which is higher than the thermal expansion coefficient of at least a portion of the support frame, such that when at least the clamping means is heated, pressure is exposed to the stack loaded into the reception region due to a thermal expansion difference.

According to a further embodiment, the clamping means may have a cavity to receive a heater element for heating the clamping means, wherein the clamping means can be further adapted to transfer heat from the heater element to the stack via a stamp head which can be formed by the end of the stamp applying pressure onto the stack.

The stamp may be included in a stamp arrangement, wherein the stamp is put on the elements to be bonded and wherein a biasing screw is associated with the stamp, which can be tightened into a corresponding opening in the support frame to pressure bias the stamp onto the stack.

According to another exemplary embodiment, a plurality of clamping means can be provided to perform the bonding of a plurality of elements in the fixture apparatus. For example, the support frame may be adapted to hold a common substrate onto which the plurality of devices are to be bonded, wherein each of the plurality of devices are clamped by means of the corresponding clamping means.

According to a further exemplary aspect, a method for bonding a plurality of elements using a sintering process to produce a stack of elements is disclosed. An exemplary method can include:
clamping the stack into the reception region of the fixture apparatus disclosed herein; and
applying heat to the elements and the bonding layer to perform a sintering process of the bonding layer after the stack has been clamped in the reception region.

Moreover, prior to or during the clamping of the stack into the reception region, a sintering pressure can be applied to the stack wherein, with the stack being clamped, the pressure on the stack is maintained.

The clamping of the stack may be further performed to fixate the stack in the reception region, wherein pressure is applied to the stack by applying heat to at least the clamping means such that pressure is generated due to the thermal expansion of the clamping means.

According to a further exemplary aspect, a use of the above fixture apparatus for sintering the bonding layer to bond the plurality of elements in the stack is disclosed, wherein the fixture apparatus is loaded with the stack and at least the clamping means of the fixture apparatus is heated at a sintering temperature.

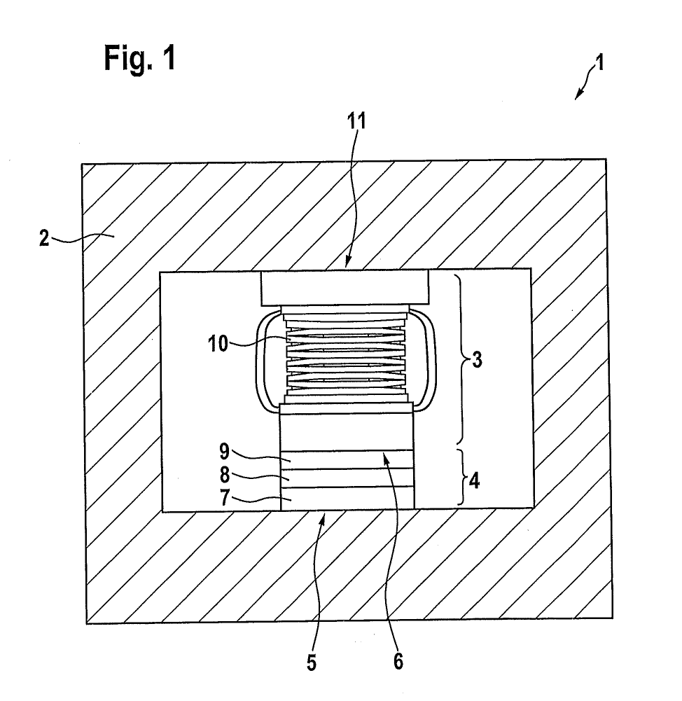

In FIG. 1, a cross-sectional view of a general fixture apparatus 1 is shown.

The fixture apparatus can be adapted to apply a permanent pressure onto a stack including a plurality of elements stacked on each other. Each of the elements contained in the stack can be an electrical device, an electronic device, an electromechanical device, a plate made of conductive or non-conductive material, such as a metal plate or a insulating plate, a semiconductor die, a metal layer, a protective layer or a substrate. In the stack the elements are, for example, stapled or stacked, respectively, such that corresponding bonding regions at which neighboring elements shall be bonded, are facing each other. For example, the elements are stackable (e.g., the elements provide bonding regions which extend substantially orthogonal to the stacking direction such that no substantial lateral force is caused between the stacked elements). For example, the stack can include a substrate, such as a silicon wafer, a printed circuit board or the like, and one or more dies (e.g., one or more silicon chips or the like, as elements). In-between the bonding regions of the elements to be bonded, a silver paste may be applied serving as a bonding material.

The exemplary fixture apparatus 1 of FIG. 1 has a frame 2, in which a pressure stamp 3 is provided. The frame 2 supports a stamp 3 which allows to clamp a stack 4 between a first pressure plane 5 of the frame 2 and a second pressure plane 6 located at the stamp 3. Between the first and the second pressure planes 5, 6, the stack 4 is arranged. In an exemplary embodiment, the stack 4 includes a substrate 7 as a first element and a chip 9 as a second element, in between which the silver paste layer 8 as a bonding material is applied. In the given example the stamp 3 puts pressure on the chip 8 while the substrate 7 abuts the frame 2.

Of course, it may also be provided that the stamp 3 presses on the substrate 7 while the chip 9 abuts the frame 2. Moreover, in an alternative embodiment two stamps may be arranged within the frame 2 which provide the respective pressure planes for putting the pressure on the stack.

The silver paste layer 8 may be made of a silver paste which is applied on the substrate 7 (first element of the stack) such that it forms a layer of equal thickness (e.g. using a squeegee) before the chip 9 is put on the silver paste layer 8 with its bonding region. The silver paste can include nanoscale silver powder having particles smaller than for example 500 nm, (e.g., 10 to 100 nm silver particles, preferably 30 nm to 50 nm silver particles, or lesser or greater). The paste may further include a solvent, for easy application of the silver paste onto the substrate 7 in a high reproducibility. The silver paste can be applied as a layer with a thickness of, for example, 30 μm to 200 μm (e.g., between 50 μm and 100 μm, or lesser or greater). Alternatively, the bonding material can include a paste which may contain a mixture of silver compounds and/or micro-size silver particles.

In an exemplary embodiment, the so formed stack 3 can be exposed to pressure and inserted into the fixture device, such that the stamp 3 presses on the stack 4 to exert a permanent pressure thereon. The pressure to be applied on the stack 4 is between, for example, 1 MPa to 20 MPa (e.g., between 5 MPa and 12 MPa, more preferably between 7 MPa and 9 MPa, such as approximately 8 MPa, or lesser or greater).

The stamp 3 can be provided with a force-applying element 10 (e.g., a spring), which is biasing the stamp 3 to apply a pressure between a stop plane 11 of the frame 2 and one side of the stack 4. The force-applying element 10 may be formed by a resilient element (e.g. a spring) and can be adapted to provide a force between the stop plane 11 of the frame 2 and the second pressure plane 6 in an extending direction of the stamp 3 (e.g., such that opposing ends of the stamp 3 are pressed apart from each other in the direction in which pressure shall be applied onto the stack 4.

After loading the fixture device 1 with the stack 4 to be bonded, the assembly can be placed into a heat chamber. In the heat chamber the assembly is heated to a temperature which allows a sintering process of the silver particles in the silver paste 8 to get started. If silver paste is used as a bonding layer, temperatures of, for example, 200 to 350° C. (e.g., 230 to 300° C., or lesser or greater) can be applied. The sintering process requires an application of heat to the silver paste for a duration of, for example, several minutes to several hours, while the thickness of the silver paste layer 9 slightly shrinks. The force-applying element 10 pushes the stamp 3 onto the stack 4 and allows a compensation of the change in the overall thickness of the stack 4 due to the shrinkage of the thickness of the silver paste layer 9.

In a manufacturing environment, a plurality of these fixture apparatuses, each loaded with one or more stacks 4, each of the stacks 4 biased with pressure by the force-applying element 10, can be exposed to heat (e.g., by introducing them into a heat chamber or the like), to perform simultaneous bonding processes by sintering the respective silver paste layers of the stacks 4.

By using a fixture apparatus 1, the process of bonding the stack 4 can be highly parallelized, such a batch processing can be performed. Thereby, the throughput can be greatly increased compared to a single bonding apparatus, as already described.

Optionally, the fixture apparatus 1 that applies the pressure to the stack 4 while sintering can be used to provide a contacting with the stack 4 even after the bonding process is completed.

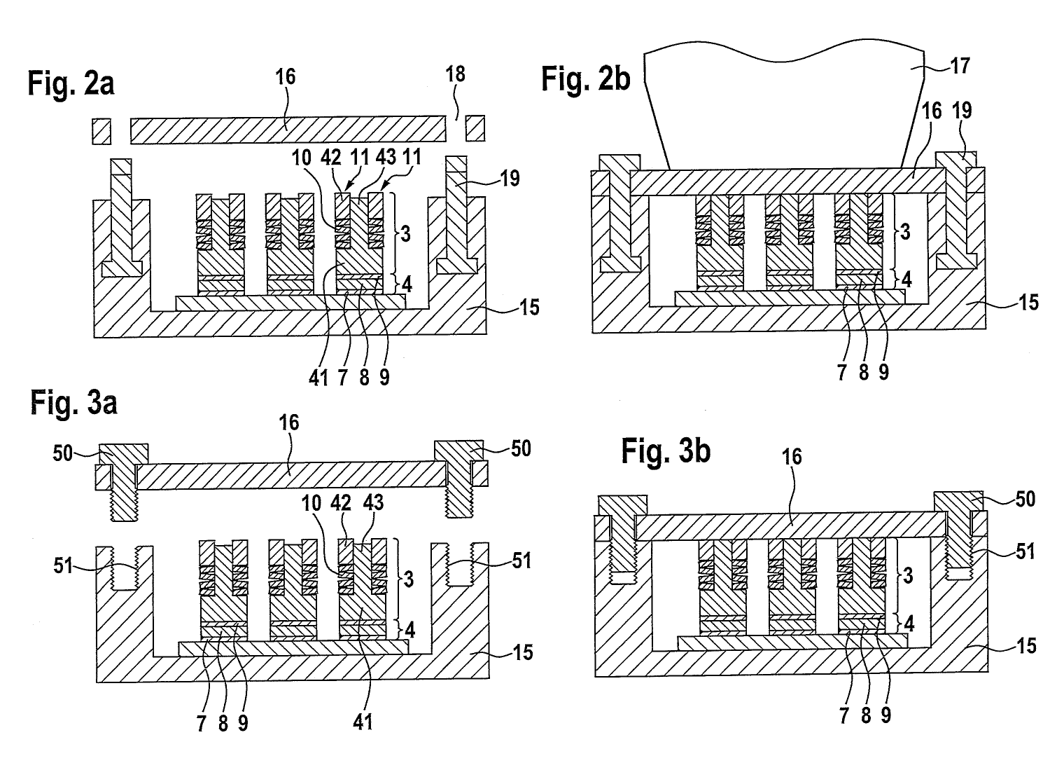

In alternative exemplary embodiments, as shown in FIGS. 2a, 2b and 3a, 3b, the support frame can be made of a support portion 15 and a pressure maintaining portion 16. In the support portion 15 three (as an example) stamps 3 are arranged which are associated to corresponding stacks 4 as described herein. Each of the stamps 3 can include the force-applying element 10. In FIG. 2a the support portion 15 and the pressure maintaining portion 16 are shown in an unassembled state wherein the force-applying element 10 is relaxed, while in FIG. 2b the pressure maintaining portion 16 is attached at the support portion 15.

As an alternative to the exemplary embodiment shown in FIG. 1, the pressure can be applied onto the stack 4 while attaching the pressure maintaining portion 16 onto the support portion 15. In an embodiment of FIGS. 2a and 2b, the pressure maintaining portion 16 is pressed onto the support portion 15 using a press stamp 17. This results in a biasing the force-applying element 10 in the stamps 3.

In detail, each stamp 3 includes a stamp portion 41 providing the second pressure plane 6 and a movable member 42 which has the first pressure plane 11 and which is guided at the stamp portion 41 by means of a guidance element 43 which protrudes from the stamp portion 41 in direction to the pressure maintaining portion 16 to be attached. In other words the movable member 42 is guided in a direction of the force applied onto the stack 4. Between the movable member 42 and the stamp portion 41, the force-applying element 10 (e.g., as a spring coil) is inserted. While assembling, the pressure maintaining portion 16 is pressed onto the support portion 15 by means of the press stamp 17 such that the movable member 42 of each stamp 3 is moved towards the stack 4 in a guided manner to load the force-applying element 10 such that a permanent pressure is applied onto the stack 4 when the frame is in an assembled state.

To maintain the pressure on the stack 4 the pressure maintaining portion 16 can have openings 18. The openings 18 can be adapted to receive a fastening bolt 19 rigidly attached to the support portion 15 such that the pressure maintaining portion 16 is locked in pressed condition onto the support portion 15 thereby maintaining the pressure on the stack 4. The locking of the pressure maintaining portion 16 can be performed by turning a locking element at an end of the fastening bolt 19 to provide a stop for the pressure maintaining portion 16 to be pushed back by the biased force-applying element 10.

In a further embodiment as shown in FIGS. 3a and 3b, the force can be generated and applied by means of fastening screws 50 which are passing through the opening 18 of the pressure maintaining portion 16 and which can be screwed into respective internal threads 51 (having a winding) included in the support portion 15. By tightening the screws 50 the force is applied onto the stamps 3 such that the force-applying element 10 (e.g. a coil spring) is biased.

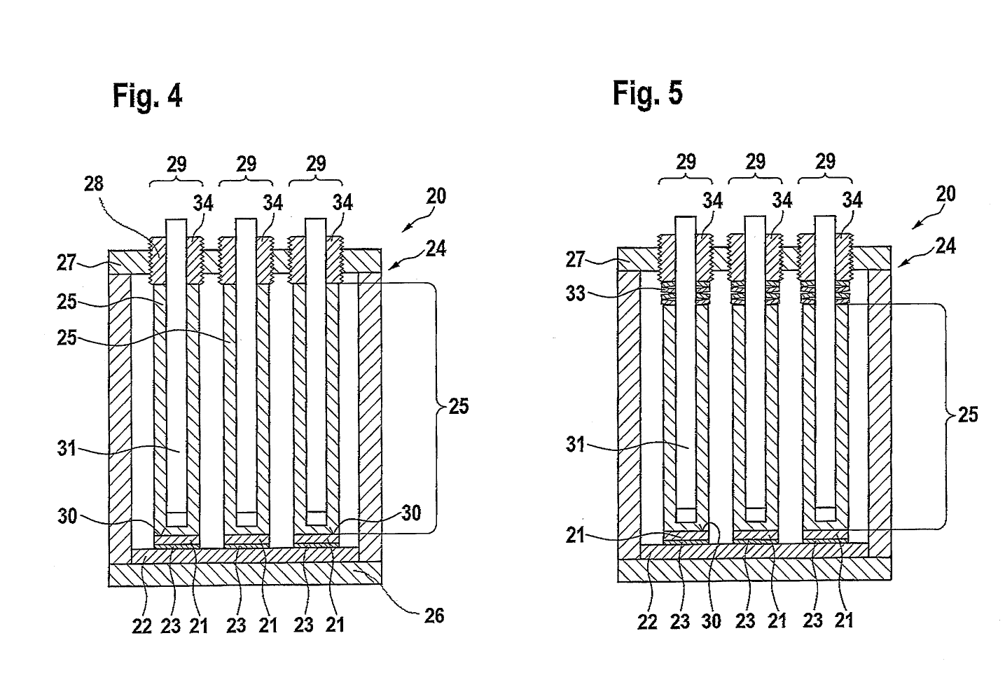

FIG. 4 shows a different exemplary embodiment of the present disclosure. In FIG. 4, a fixture apparatus 20 is shown for supporting a bonding process of a plurality of chips 21 onto a common substrate 22. After applying a respective silver paste layer 23 between the chips 21 and the common substrate 22, the so formed stack is loaded into the fixture apparatus 20.

The fixture apparatus 20 includes a frame 24 having stamps 25, each associated to one of the chips 21 of the stack. The fixture device 20 includes a bottom plate 26 which provides a supporting plane to hold the stack formed by the substrate 22 and the chips 21. The bottom plate 26 may be provided with a heat source such that heat can be applied to the stack via the first supporting plane.

The fixture apparatus 20 further includes a top plate 27 having openings 28 through which stamp arrangements 29 are inserted into the frame 24 such that they are projecting towards a corresponding chip 21 of the stack. Each of the stamp arrangements 29 include one of the stamps 25, which comprises a pressure region 30 which is associated to a corresponding one of the chips 21 of the stack. The stamp 25 can, for example, have a cylindrical shape with a circular cross-section, with a cross-section of another shape or with a cross-section of a shape which corresponds to the surface of the chip 21 to be bonded or which is greater than the surface of the chip 21. At least the pressure region 30 of each stamp 25 can have a shape which allows equal exposure of pressure onto the corresponding one of the chips 21.

Instead of using a heat chamber to apply the heat to the silver paste layer 23 by exposing the whole fixture apparatus to a heat environment, the stamp 25 can include heating means which allow to directly produce heat in or at the stamp 25. For instance, and as shown in the given example, the stamp 25 may be provided with a cavity which has its opening on a side of the stamp 25 opposite to the pressure plane 30. Then a heat source (e.g., an electrically heated rod or the like), can be inserted into the respective cavity 32 of each of the stamps 25.

The stack may be pressure biased by means of biasing screws 34, which allow biasing the stamp 25 such that an initial pressure is applied onto the respective chip 21 of the stack before the whole assembly having the fixture apparatus 20 loaded with the stack is performing a sintering operation by applying heat to the chips 21 on the stack.

To produce the necessary pressure while exposing the stack to a sintering temperature, the stamp 25 may be made of a material having a high thermal expansion coefficient while the frame 24 of the fixture apparatus 20 has a lower thermal expansion coefficient, such that, when heat is applied to the stamp, the thermal expansion of the stamp 25 is larger than that of the frame 24 of the fixture apparatus 20. Thereby, the stack can be loaded into the fixture apparatus 20 without the need of an additional pressing process for prepressurizing the stack before loading it into the fixture apparatus 20. In other words, a pressure biasing of the stack at a room temperature is not necessary.

The stack may be loaded into the fixture apparatus 20 by inserting the stack onto the bottom plate 26, arranging the stamp 25 onto the chips 21 and tying up the biasing screw 34 such that the stamp 25 engages with the respective chip 21 via pressure plane 30. While heating the stamp 25, the higher thermal expansion of the stamp 25 results in an increasing pressure on the stack, such that both the bonding temperature for sintering the silver paste layer 23 and the pressure required by the bonding process are simultaneously applied.

Another exemplary embodiment, which is shown in FIG. 5 is similar to the embodiment of FIG. 4. In difference, further biasing means 33 are provided between the biasing screws 34 and the stamp 25. The biasing means 33 are, for example, formed as springs in order to provide a permanent pressure when loaded. Thereby, a bias pressure can be applied to the chips 21 of the stack already at room temperature. One exemplary benefit of such a fixture apparatus 20 is that the sintering pressure applied to the chips 21 while heated can be maintained more constant, even when the thickness of the bonding layer 23 shrinks during the sintering process.

The stamp 25 may contain aluminum or zinc as example materials. As an exemplary material for the frame 24 of the fixture apparatus 20, invar can be used.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

1 Fixture apparatus
2 Frame
3 Stamp
4 Stack
5 First pressure plane
6 Second pressure plane
7 Substrate
8 Bonding layer
9 Chip
10 Force-applying element
11 Stop plane
15 Support portion
16 Pressure maintaining portion
17 Pressure stamp
18 Opening
19 Fastening bolt
20 Fixture apparatus
21 Chip
22 Substrate
23 Bonding layer
24 Frame
25 Stamp
26 Bottom plate
27 Top plate
28 Openings
29 Stamp arrangement
30 Pressure plane
31 Cavity
33 Biasing means
34 Biasing screw
41 Stamp portion
42 Movable member
43 Guidance element
50 Fastening screw
51 Internal thread

What is claimed is:

1. Fixture apparatus for bonding plural elements by sintering a bonding layer between the elements, the apparatus comprising:
a support frame;
a clamping means; and
a reception region for receiving a stack having plural elements, in-between which a bonding layer is arranged, the clamping means clamping a stack when loaded into the reception region for permanently applying a sintering pressure.

2. Fixture apparatus according to claim 1, wherein the clamping means is configured to receive a stack biased with the sintering pressure, and for clamping the stack while maintaining the sintering pressure.

3. Fixture apparatus according to claim 1, wherein the support frame comprises:
a support portion; and
a pressure maintaining portion, wherein the sintering pressure is applied on the stack received in the reception region by assembling the support portion and the pressure maintaining portion, thereby biasing a force-applying element of the clamping means to provide the sintering pressure.

4. Fixture apparatus according to claim 3, comprising:
fastening means for fastening the support portion and the pressure maintaining portion.

5. Fixture apparatus according to claim 1, wherein the sintering pressure is between 1 MPa to 20 MPa.

6. Fixture apparatus according to claim 1, wherein the clamping means comprises:
a resilient element.

7. Fixture apparatus according to claim 1, wherein the clamping means comprises:
a stamp which includes a material having a thermal expansion coefficient which is higher than a thermal expansion coefficient of at least a portion of the support frame, such when the clamping means is heated, pressure is exposed to the stack loaded into the reception region due to a thermal expansion difference.

8. Fixture apparatus according to claim 1, wherein the clamping means comprises:
a cavity to receive a heater element for heating the clamping means, wherein the clamping means is configured for transferring the heat from the heater element to the stack via a stamp head which is formed by the end of the stamp applying pressure onto the stack.

9. Fixture apparatus according to claim 1, wherein the stamp is included in a stamp arrangement wherein the stamp is placed on the elements to be bonded, and wherein a biasing screw is associated with the stamp which can be tied into a corresponding opening in the support frame to pressure bias the stamp onto the stack.

10. Fixture apparatus according to claim 1, comprising:
a plurality of clamping means for performing the bonding of plural elements in the fixture apparatus.

11. Fixture apparatus according to claim 10, wherein the support frame is configured to hold a common substrate onto which the plural elements are to be bonded, wherein each of the plural elements are clamped by means of respective clamping means.

12. Method for bonding plural elements by a sintering process to produce a stack of elements, comprising:
clamping the stack into a reception region of a fixture apparatus which includes a support frame, a clamping means, and the reception region for receiving a stack having plural elements, in-between which a bonding layer is arranged, the clamping means clamping the stack when loaded into the reception region for permanently applying a sintering pressure; and
applying heat to the elements and the bonding layer to perform a sintering process of the bonding layer after the stack has been clamped to the reception region.

13. Method according to claim 12, comprising:
prior to or during the clamping of the stack into the reception region, applying a sintering pressure to the stack wherein, with the stack being clamped, the pressure on the stack is maintained.

14. Method according to claim 12, comprising:
clamping the stack to fixate the stack in the reception region wherein pressure is applied to the stack by applying heat to at least the clamping means, such that pressure is generated due to thermal expansion of the clamping means.

15. Method according to claim 12 comprising:
sintering the bonding layer to bond the plural elements in the stack, wherein the fixture apparatus is loaded with the stack and at least the clamping means of the fixture apparatus is heated at a sintering temperature.

16. Fixture apparatus according to claim 4, wherein the fastening means include at least one of a server and a fastening bolt.

17. Fixture apparatus according to claim 4, wherein the sintering pressure is between 1 MPa to 20 MPa.

18. Fixture apparatus according to claim 17, wherein the clamping means comprises:
a resilient element.

19. Fixture apparatus according to claim 18, wherein the clamping means comprises:
a stamp which includes a material having a thermal expansion coefficient which is higher than a thermal expansion coefficient of at least a portion of the support frame, such when the clamping means is heated, pressure is exposed to the stack loaded into the reception region due to a thermal expansion difference.

20. Fixture apparatus according to claim 19, wherein the clamping means comprises:
a cavity to receive a heater element for heating the clamping means, wherein the clamping means is configured for transferring the heat from the heater element to the stack via a stamp head which is formed by the end of the stamp applying pressure onto the stack.

21. Fixture apparatus according to claim 20, wherein the stamp is included in a stamp arrangement wherein the stamp is placed on the elements to be bonded, and wherein a biasing screw is associated with the stamp which can be tied into a corresponding opening in the support frame to pressure bias the stamp onto the stack.

22. Fixture apparatus according to claim 21, comprising:
a plurality of clamping means for performing the bonding of plural elements in the fixture apparatus.
